(19) United States
(12) Patent Application Publication
(10) Pub. No.: US 2008/0112416 A1
(43) Pub. Date: May 15, 2008

(54) NETWORK DEVICE AND METHOD FOR UPDATING FIRMWARE

(75) Inventors: CHENG-Yi HSIEH, Taipei Hsien (TW); MENG-SHU LEE, Taipei Hsien (TW)

Correspondence Address: PCE INDUSTRY, INC.;ATT. CHENG-JU CHIANG, 458 E. LAMBERT ROAD, FULLERTON, CA, 92835, US

(73) Assignee: HON HAI PRECISION INDUSTRY CO., LTD., Taipei Hsien (TW)

(21) Appl. No.: 11/616,907

(22) Filed: Dec. 28, 2006

(30) Foreign Application Priority Data
Nov. 10, 2006 (TW) 95141725

(51) Int. Cl. H04L 12/56

(52) U.S. Cl. 370/395.52

(57) ABSTRACT

A network device includes a storage module, a receiving module, a flag determining module, a type determining module, an updating determining module, and a forwarding module. The storage module saves a value of a firmware-updating flag and a preset forwarding packet corresponding to a particular web page. The receiving module receives a packet from a terminal device to send to the flag determining module. The flag determining module determines whether the firmware of the network device needs updating after receiving the packet. The type determining module determines whether the packet is a TCP packet. The updating determining module determines whether a destination address of the packet matches a destination address of the preset forwarding packet. The forwarding module receives the preset forwarding packet from the updating determining module, and sends the preset forwarding packet to the terminal device to notify the terminal device to download the newest firmware.

### BACKGROUND OF THE INVENTION

1. Field of the Invention

The invention relates to network devices, and particularly to a network device and method for updating firmware thereof.

2. Description of Related Art

Electronic communication networks have become more and more popular due to developments in communication technology, and there are more and more users of networks. Modems are key devices for users to connect to the networks. Firmware of modems needs constant updating due to developments of the networks. Conventionally, if a modem needs firmware updating, the modem retrieves a public Internet protocol (IP) address via the dynamic host configuration protocol (DHCP), downloads the newest firmware via the IP address, and then the modem compares versions of the downloaded firmware and previous firmware. If the versions are different, the downloaded firmware replaces the previous firmware. Thus, the firmware of the modem is updated. Currently, some conventional systems will check updates every time when the systems are started. According to previously recorded update marks in the systems, the systems can automatically download updates for their firmware.

However, when the modem needs to update firmware, the modem needs to retrieve a public IP address, which results in an inconvenient updating process.

### SUMMARY OF THE INVENTION

In one aspect of the invention, a network device includes a storage module, a receiving module, a flag determining module, a type determining module, an updating determining module, and a forwarding module. The storage module is for saving a value of a firmware-updating flag of the network device and a preset forwarding packet corresponding to a particular web page for downloading firmware. The receiving module connected to a terminal device is for receiving a packet sent by the terminal device and sending the packet. The flag determining module connected to the receiving module and the storage module is for receiving the packet from the receiving module and determining whether the firmware of the network device needs to be updated. The type determining module connected to the flag determining module is for receiving the packet from the flag determining module and determining whether the packet is a transfer control protocol (TCP) packet. The updating determining module connected to the type determining module and the storage module is for receiving the packet from the type determining module and determining whether a destination address of the packet matches a destination address of the preset forwarding packet. The forwarding module is connected to the updating determining module and the terminal device, for receiving the preset forwarding packet from the updating determining module and sending the preset forwarding packet to the terminal device to notify the terminal device to download the newest firmware from the particular web page corresponding to the preset forwarding packet.

In another aspect of the invention, a method for updating firmware of a network device includes steps of: setting a value of a firmware-updating flag of the network device, and saving the value of the firmware-updating flag; receiving a packet sent by a terminal device; determining whether the firmware of the network device needs to be updated; determining whether the packet is a transfer control protocol (TCP) packet if the firmware of the network device needs to be updated; determining whether a destination address of the packet matches a destination address of a preset forwarding packet if the packet is a TCP packet; and sending the preset forwarding packet corresponding to a particular web page for downloading firmware to the terminal device to make the terminal device download the newest firmware of the network device from the particular web page if the destination address of the packet does not match the destination address of the preset forwarding packet.

Other advantages and novel features will become more apparent from the following detailed description when taken in conjunction with the accompanying drawings.

### BRIEF DESCRIPTION OF THE DRAWINGS

FIG. 1 is a schematic diagram of a network device of an exemplary embodiment of the invention.

FIG. 2 is a flowchart of a method for updating firmware of another exemplary embodiment of the invention.

### DETAILED DESCRIPTION OF THE INVENTION

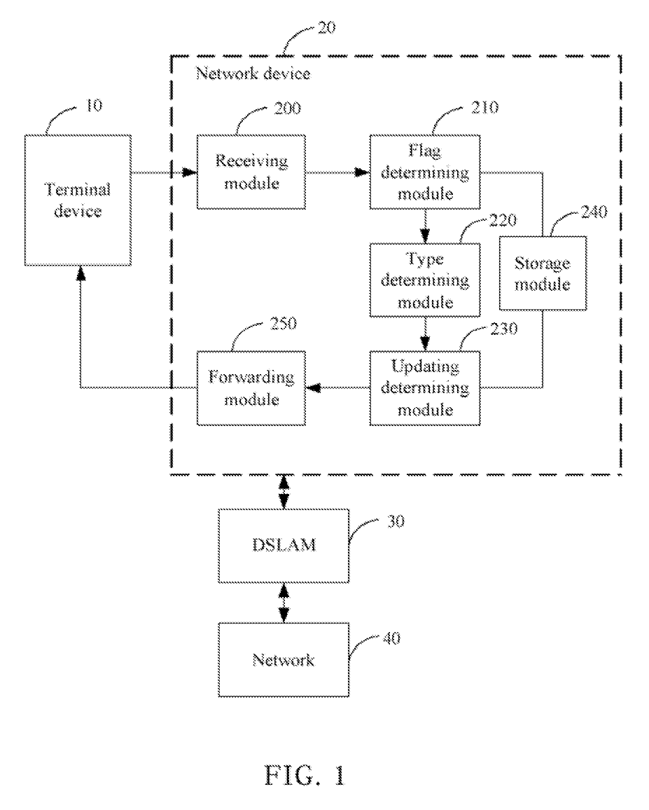

FIG. 1 is a schematic diagram of a network device 20 of an exemplary embodiment of the invention. The network device 20 connects a terminal device 10, such as a personal computer, to a network 40 via a digital subscriber line access multiplexer (DSLAM) 30. In the exemplary embodiment, the network device 20 may be a modem. The DSLAM 30 sets a value of a firmware-updating flag of the network device 20. If the DSLAM 30 detects that firmware of the network device 20 needs updating, the DSLAM 30 sets the value of the firmware-updating flag of the network device 20 via the simple network management protocol (SNMP). Thus, the network device 20 can download the newest firmware from the network 40 via the terminal device 10. In the exemplary embodiment, the value of the firmware-updating flag may include “1” and “0”. The digit “1” indicates that the network device 20 needs firmware updating while the digit “0” indicates that the network device 20 needs no firmware updating. In the exemplary embodiment, the DSLAM 30 can only set the value of the firmware-updating flag of the network device 20 as “1.”

In alternative embodiments of the invention, the value of the firmware-updating flag of the network device 20 may include different digits or letters.

In the exemplary embodiment, the network device 20 is connected to the terminal device 10 and the DSLAM 30, and includes a receiving module 200, a flag determining module 210, a type determining module 220, an updating determining module 230, a storage module 240, and a forwarding module 250.

The storage module 240 is used for saving the value of the firmware-updating flag of the network device 20 and a preset forwarding packet. The preset forwarding packet corresponds to a particular web page for downloading the newest firmware, and includes a destination address.

The receiving module 200 is connected to the terminal device 10, and is used for receiving a packet sent by the terminal device 10 and sending the packet to the flag determining module 210.

The flag determining module 210 is connected to the receiving module 200 and the storage module 240, and is used for receiving the packet from the receiving module 200 and determining whether the firmware of the network device 20 needs to be updated. In the exemplary embodiment, the flag determining module 210 acquires the value of the firmware-updating flag of the network device 20 saved in the storage module 240 to determine whether the firmware of the network device 20 needs to be updated. If the acquired value of the firmware-updating flag is “1,” the flag determining module 210 determines that the firmware of the network device 20 needs to be updated, and sends the packet to the type determining module 220. If the acquired value of the firmware-updating flag is “0,” the flag determining module 210 determines that the firmware of the network device 20 does not need to be updated, and sends the packet to a destination of the packet to communicate normally.

The type determining module 220 is connected to the flag determining module 210, and is used for receiving the packet from the flag determining module 210 and determining whether the packet is a transfer control protocol (TCP) packet. In the exemplary embodiment, the type determining module 220 determines a type of the packet according to a value of a protocol field of the packet. If the value of the protocol field of the packet is “6,” the packet is a TCP packet. If the packet is not a TCP packet, the type determining module 220 sends the packet to the destination of the packet to communicate normally. If the packet is a TCP packet, the type determining module 220 further determines whether the packet is a web-page browsing packet. In the exemplary embodiment, the type determining module 220 determines whether the packet is a web-page browsing packet according to a value of a header field of the packet. If the value of the header field of the packet is “port 80,” the packet is a web-page browsing packet. If the type determining module 220 determines that the packet is a web-page browsing packet, the type determining module 220 sends the packet to the updating determining module 230. If the packet is not a web-page browsing packet, the type determining module 220 sends the packet to the destination of the packet to communicate normally.

The updating determining module 230 is connected to the type determining module 220 and the storage module 240, and is used for receiving the packet from the type determining module 220 and determining whether a destination address of the packet matches the destination address of the preset forwarding packet. In the exemplary embodiment, the updating determining module 230 acquires the destination address of the preset forwarding packet from the storage module 240, and compares the destination address of the preset forwarding packet with the destination address of the packet to determine whether the destination address of the packet matches the destination address of the preset forwarding packet. If the destination addresses of the preset forwarding packet and the packet are the same, the updating determining module 230 determines that the packet the destination address of the packet matches the destination address of the preset forwarding packet, changes the value of the firmware-updating flag in the storage module 240 to indicate that the firmware of the network device does not need to be updated, that is, changes the value of the firmware-updating flag to be “0,” and sends the packet to the destination corresponding to the destination address of the packet to communicate normally. If the destination addresses of the preset forwarding packet and the packet are different, the updating determining module 230 sends the preset forwarding packet to the forwarding module 250.

The forwarding module 250 is connected to the updating determining module 230 and the terminal device 10, and is used for receiving the preset forwarding packet from the updating determining module 230 and sending the preset forwarding packet to the terminal device 10. In the exemplary embodiment, the forwarding module 250 sends the preset forwarding packet to the terminal device 10 via hypertext transfer protocol (HTTP). After the terminal device 10 receives the preset forwarding packet, a browsing web page of the terminal device 10 is redirected to the particular web page corresponding to the preset forwarding packet. Then the terminal device 10 downloads the newest firmware of the network device 20 from the particular web page, and sends the downloaded firmware to the network device 20 to update the firmware of the network device 20.

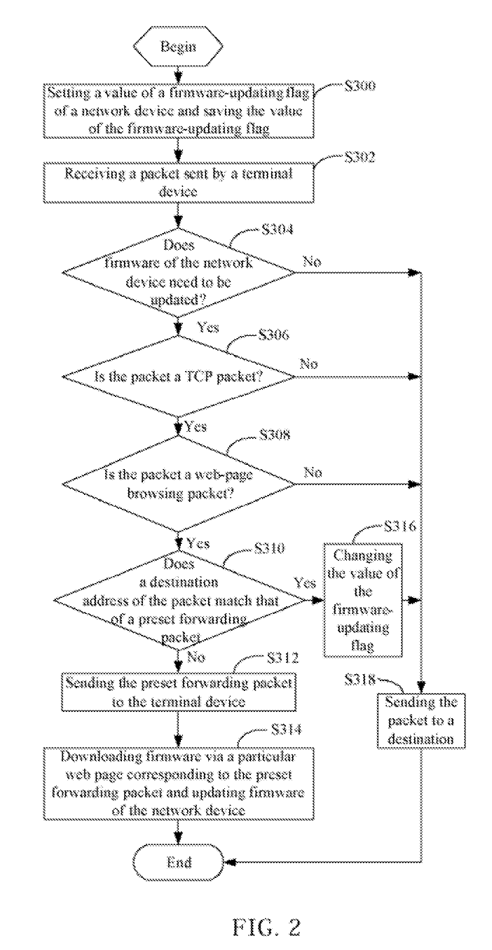

FIG. 2 is a flowchart of a method for updating firmware of an exemplary embodiment. The terminal device 10 first connects to the network 40, for example, the Internet, through the network device 20 to establish data communication between the terminal device 10 and the network 40. The network device 20 then notifies the terminal device 10 to send out the preset forwarding packet to the particular web page to request for updates for the firmware of the network device 20 if the updates are determined to be available on the particular web page according to the firmware-updating flag. The terminal device 10 hence downloads the updates and update the firmware of the network device 20. Accordingly, in detail, in step S300 of the flowchart, the DSLAM 30 set the value of the firmware-updating flag of the network device 20 via the SNMP, and saves the value of the firmware-updating flag of the network device 20 in the storage module 240. In the exemplary embodiment, if the DSLAM 30 detects that firmware of the network device 20 needs updating, the DSLAM 30 sets the value of the firmware-updating flag of the network device 20 using simple network management protocol (SNMP). In the exemplary embodiment, the value of the firmware-updating flag may include “1” and “0”. The digit “1” indicates that the network device 20 needs firmware updating while the digit “0” indicates that the network device 20 needs no firmware updating. In the exemplary embodiment, the DSLAM 30 can only set the value of the firmware-updating flag of the network device 20 as “1.”

In step S302, the receiving module 200 of the network device 20 receives a packet sent by the terminal device 10, and sends the packet to the flag determining module 210.

In step S304, the flag determining module 210 determines whether the firmware of the network device 20 needs to be updated. In the exemplary embodiment, the flag determining module 210 acquires the value of the firmware-updating flag of the network device 20 saved in the storage module 240 to determine whether the firmware of the network device 20 needs to be updated.

If the acquired value of the firmware-updating flag is “0,” then the flag determining module 210 determines that the firmware of the network device 20 does not need to be updated, in step S318, the network device 20 sends the packet to a destination of the packet to communicate normally.

If the acquired value of the firmware-updating flag is “1,” then the flag determining module 210 determines that the firmware of the network device 20 needs to be updated, in step S306, the flag determining module 210 sends the packet to the type determining module 220, and the type determining module 220 determines whether the packet is a TCP packet. In the exemplary embodiment, the type determining module 220 determines the type of the packet according to a value of a protocol field of the packet. If the value of the protocol field of the packet is “6,” the packet is a TCP packet.

If the type determining module 220 determines that the packet is not a TCP packet, in step S318, the network device 20 sends the packet to the destination of the packet to communicate normally.

If the type determining module 220 determines that the packet is a TCP packet, in step S308, the type determining module 220 determines whether the packet is a web-page browsing packet. In the exemplary embodiment, the type determining module 220 determines whether the packet is a web-page browsing packet according to a value of a header field of the packet. If the value of the header field of the packet is “port 80,” the packet is a web-page browsing packet.

If the type determining module 220 determines that the packet is not a web-page browsing packet, in step S318, the network device 20 sends the packet to the destination of the packet to communicate normally.

If the type determining module 220 determines that the packet is a web-page browsing packet, in step S310, the type determining module 220 sends the packet to the updating determining module 230, and the updating determining module 230 determines whether a destination address of the packet matches a destination address of the preset forwarding packet. In the exemplary embodiment, the updating determining module 230 acquires the destination address of the preset forwarding packet from the storage module 240, and compares the destination address of the preset forwarding packet with the destination address of the packet to determine whether the destination address of the packet matches the destination address of the preset forwarding packet.

If the destination addresses of the preset forwarding packet and the packet are different, that is the destination address of the packet does not match the destination address of the preset forwarding packet, in step S312, the updating determining module 230 sends the preset forwarding packet to the forwarding module 250, and the forwarding module 250 sends the preset forwarding packet to the terminal device 10 via the HTTP.

In step S314, the terminal device 10 downloads the newest firmware from the particular web page, and updates the firmware of the network device 20. In the exemplary embodiment, the terminal device 10 receives the preset forwarding packet, and a browsing web page of the terminal device 10 is redirected to the particular web page corresponding to the preset forwarding packet. Then the terminal device 10 downloads the firmware of the network device 20 from the particular web page, and sends the downloaded firmware to the network device 20 to update the firmware of the network device 20.

If the destination addresses of the preset forwarding packet and the packet are the same, that is the destination address of the packet matches the destination address of the preset forwarding packet, in step S316, the updating determining module 230 changes the value of the firmware-updating flag in the storage module 240 to indicate that the firmware of the network device does not need to be updated, that is, changes the value of the firmware-updating flag to be “0,” and saves the changed value of the firmware-updating flag in the storage module 240. Then the process goes to step S318, the network device 20 sends the packet to the destination corresponding to the destination address of the packet to communicate normally. If the destination addresses of the preset forwarding packet and the packet are the same, that is, the packet is the same as the preset forwarding packet, the network device 20 sends the packet to the destination, that is the particular web page, to download the newest firmware.

The network device 20 can update firmware without retrieving a public IP address, thereby making the firmware updating process simple and convenient.

The foregoing disclosure of various embodiments has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims appended hereto and their equivalents.

What is claimed is:

1. A network device, comprising:
a storage module, for saving a value of a firmware-updating flag of the network device and a preset forwarding packet corresponding to a particular web page for downloading firmware;
a receiving module connected to a terminal device, for receiving a packet sent by the terminal device and sending the packet;
a flag determining module connected to the receiving module and the storage module, for receiving the packet from the receiving module and determining whether the firmware of the network device needs to be updated;
a type determining module connected to the flag determining module, for receiving the packet from the flag determining module and determining whether the packet is a transfer control protocol (TCP) packet;
an updating determining module connected to the type determining module and the storage module, for receiving the packet from the type determining module and determining whether a destination address of the packet matches a destination address of the preset forwarding packet; and
a forwarding module connected to the updating determining module and the terminal device, for receiving the preset forwarding packet from the updating determining module and sending the preset forwarding packet to the terminal device to notify the terminal device to download the newest firmware from the particular web page corresponding to the preset forwarding packet.

2. The network device of claim 1, wherein the flag determining module determines whether the firmware of the network device needs to be updated according to the value of the firmware-updating flag of the network device.

3. The network device of claim 1, wherein the flag determining module sends the packet to the type determining module if the flag determining module determines that the firmware of the network device does not need to be updated.

4. The network device of claim 1, wherein the type determining module determines whether the packet is a TCP packet according to a value of a protocol field of the packet.

5. The network device of claim 1, wherein the type determining module further determines whether the packet is a web-page browsing packet if the type determining module determines that the packet is a TCP packet.

6. The network device of claim 5, wherein the type determining module determines whether the packet is a web-page browsing packet according to a value of a header field of the packet.

7. The network device of claim 5, wherein the type determining module sends the packet to the updating determining module if the type determining module determines that the packet is a web-page browsing packet.

8. The network device of claim 1, wherein the updating determining module acquires the destination address of the preset forwarding packet from the storage module, and compares the destination address of the preset forwarding packet with the destination address of the packet to determine whether the destination address of the packet matches the destination address of the preset forwarding packet.

9. The network device of claim 1, wherein the updating determining module changes the value of the firmware-updating flag in the storage module to indicate that the firmware of the network device does not need to be updated, and saves the changed value of the firmware-updating flag in the storage module if the updating determining module determines that the destination address of the packet matches the destination address of the preset forwarding packet.

10. The network device of claim 1, wherein the updating determining module sends the preset forwarding packet to the forwarding module if the updating determining module determines that the destination address of the packet does not match the destination address of the preset forwarding packet.

11. A method for updating firmware of a network device, comprising:
setting a value of a firmware-updating flag of the network device, and saving the value of the firmware-updating flag;
receiving a packet sent by a terminal device;
determining whether the firmware of the network device needs to be updated;
determining whether the packet is a transfer control protocol (TCP) packet if the firmware of the network device needs to be updated;
determining whether a destination address of the packet matches a destination address of a preset forwarding packet if the packet is a TCP packet; and
sending the preset forwarding packet corresponding to a particular web page for downloading firmware to the terminal device to make the terminal device download the newest firmware of the network device from the particular web page if the destination address of the packet does not match the destination address of the preset forwarding packet.

12. The method for updating firmware of claim 11, wherein the step of determining whether the firmware of the network device needs to be updated comprises steps of:
determining whether the firmware of the network device needs to be updated according to the value of the firmware-updating flag of the network device.

13. The method for updating firmware of claim 11, wherein the step of determining whether the packet is a TCP packet comprises steps of:
determining whether the packet is a TCP packet according to a value of a protocol field of the packet.

14. The method for updating firmware of claim 11, further comprising steps of:
determining whether the packet is a web-page browsing packet if the packet is a TCP packet.

15. The method for updating firmware of claim 14, wherein the step of determining whether the packet is a web-page browsing packet comprises steps of:
determining whether the packet is a web-page browsing packet according to a value of a header field of the packet.

16. The method for updating firmware of claim 11, wherein the step of determining whether a destination address of the packet matches a destination address of a preset forwarding packet comprises steps of:
acquiring the destination address of the preset forwarding packet; and
comparing the destination address of the preset forwarding packet with the destination address of the packet to determine whether the destination address of the packet matches the destination address of the preset forwarding packet.

17. The method for updating firmware of claim 11, wherein the step of sending the preset forwarding packet corresponding to a particular web page for downloading firmware to the terminal device to make the terminal device download the newest firmware of the network device from the particular web page comprises steps of:
sending the preset forwarding packet to a forwarding module;
sending the preset forwarding packet to the terminal device via hypertext transfer protocol; and
downloading the newest firmware from the particular web page corresponding to the preset forwarding packet by the terminal device, and sending the downloaded firmware to the network device.

18. The method for updating firmware of claim 11, further comprising steps of:
changing the value of the firmware-updating flag to indicate that the firmware of the network device does not need to be updated if the updating determining module determines that the destination address of the packet matches the destination address of the preset forwarding packet; and
saving the changed value of the firmware-updating flag.

19. A method for updating firmware of a network device, comprising steps of:
establishing data communication between a terminal device and a network through a network device;
notifying said terminal device by said network device to send a preset forwarding packet, which comprises a destination address of a destination in said network, to said destination according to said destination address when an update of firmware of said network device is available at said destination; and
updating said firmware of said network device via said terminal device after said update of said firmware is downloaded by said terminal device.

20. The method of claim 19, further comprising a step of setting a firmware-updating flag in the network device to decide whether said update of said firmware of said network device is available at said destination.
